(19) United States
(12) Patent Application Publication
(10) Pub. No.: US 2010/0212146 A1
(43) Pub. Date: Aug. 26, 2010

(54) CABLE CONNECTOR GRASPING APPARATUS

(75) Inventor: Jason HAMILTON, Cambridge (CA)

Correspondence Address: FASKEN MARTINEAU DUMOULIN LLP, 4200 TORONTO DOMINION BANK TOWER, BOX 20 TORONTO-DOMINION CENTRE, TORONTO, ON, M5K 1N6, CA

(73) Assignee: Research In Motion Limited

(21) Appl. No.: 12/392,741

(22) Filed: Feb. 25, 2009

(51) Int. Cl. H01R 43/22

(52) U.S. Cl. 29/747

(57) ABSTRACT

There is disclosed an apparatus for grasping a cable connector. In an embodiment, the apparatus has a generally elongate body; an anvil face positioned at a first end of the generally elongate body; a cable connector grasping tip positioned at the first end of the generally elongate body, the cable connector grasping tip adapted to be positionable into an extended position and a retracted position relative to the anvil face; biasing means adapted to urge the cable connector grasping tip into the retracted position; and a pad positioned at a second end of the generally elongate body, the pad adapted to be depressible against the biasing means to urge the cable connector grasping tip into the extended position.

### FIELD OF THE INVENTION

The present invention relates generally to an apparatus for use in electronics assembly, and more particularly to an apparatus for grasping a cable connector for insertion into a receptacle.

### BACKGROUND

In electronics assembly and manufacturing, a printed circuit board (PCB) is often used to lay down circuits and to provide a base for mounting various types of electronic components. The circuits in the PCBs may comprise electrically conductive pathways traced or etched from conductive material (e.g. copper sheets) onto a non-conductive substrate. Multiple layers of these conductive pathways may be separated by alternating layers of non-conductive substrates in order to form a laminate board that may include many layers of circuits and non-conductive substrates.

For some types of electronics assembly, an off-board module may be connected to a PCB using specialized cables and connectors, such as a coaxial cable with a connector adapted for connection to a corresponding receptacle provided on the PCB. In certain applications, such as handheld mobile devices, the PCB and the module may need to be placed inside a housing in which space is at a premium, so the cable is sized to take up little space. Due to their small dimensions, the cable and its connector may be difficult to handle manually, and this difficulty may be made worse if an assembly worker is also wearing ESD (electrostatic discharge) gloves which may decrease grip and tactile feel.

### BRIEF DESCRIPTION OF THE DRAWINGS

In the figures which illustrate exemplary embodiments:

FIG. 1A shows an isometric view of an illustrative embodiment of the apparatus;

FIG. 1B shows a detailed isometric view of a cable and a cable connector;

FIG. 2 shows an exploded isometric view of the apparatus of FIG. 1 with its various components; and

FIGS. 3A and 3B show illustrative views of the cable connector grasping prongs in two positions when the apparatus is in use.

### DETAILED DESCRIPTION

As noted above, the present invention relates to an apparatus for grasping a cable connector for insertion into a receptacle.

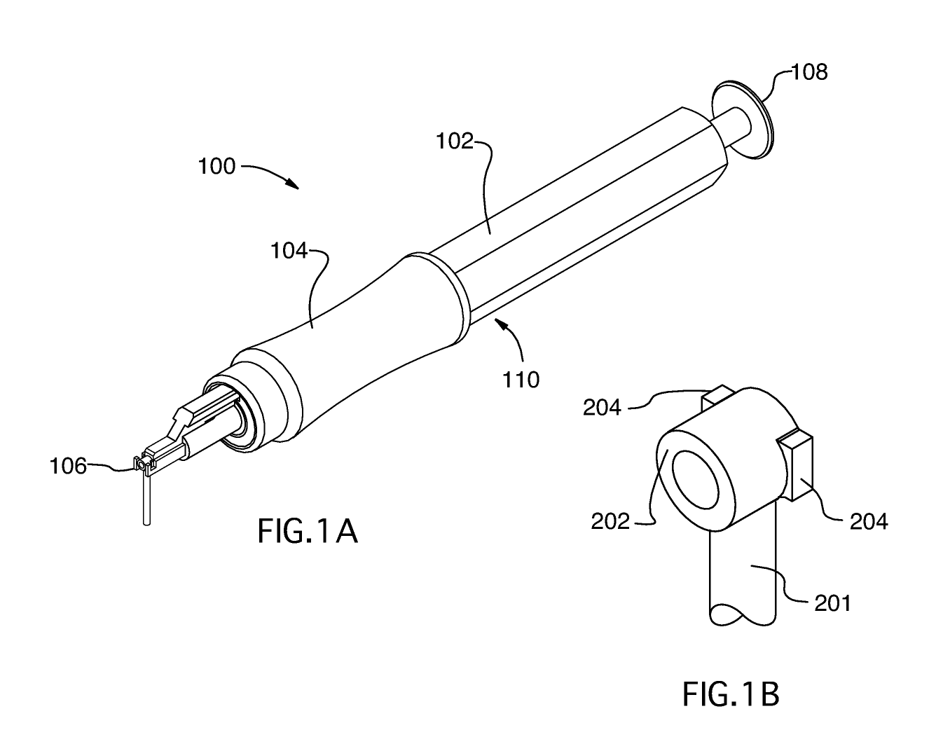

Referring to FIGS. 1A and 1B, shown in FIG. 1A is an isometric view of an apparatus 100 for grasping a cable connector in accordance with an illustrative embodiment. As shown, apparatus 100 has a generally elongated shape, and may be similar in size and proportion to a writing instrument such as a pen or a mechanical pencil.

The apparatus 100 has a generally elongate body 110 with an upper handle 102 and a grip 104 for allowing a secure and comfortable hold. A grasping tip 106 suitably adapted to grasp a cable connector is positioned at a first end of main body 110, and a button or pad 108 which may be depressed to operate the grasping tip 106 is provided at a second end of main body 110. As will be evident from the figures and the accompanying description, when two elements are “positioned” or “provided” with respect to on another, they may be, but need not be, directly physically coupled to one another. The operation of apparatus 100 will be described in more detail further below.

Shown in FIG. 1B is a detailed view of a cable 201 having a cable connector 202 adapted for insertion into a matching receptacle (not shown) provided on a PCB. As shown in FIG. 1B, cable connector 202 includes flanges 204 extending from either side of cable connector 202 for the purposes of pushing or pulling cable connector 202 into or out of a matching receptacle.

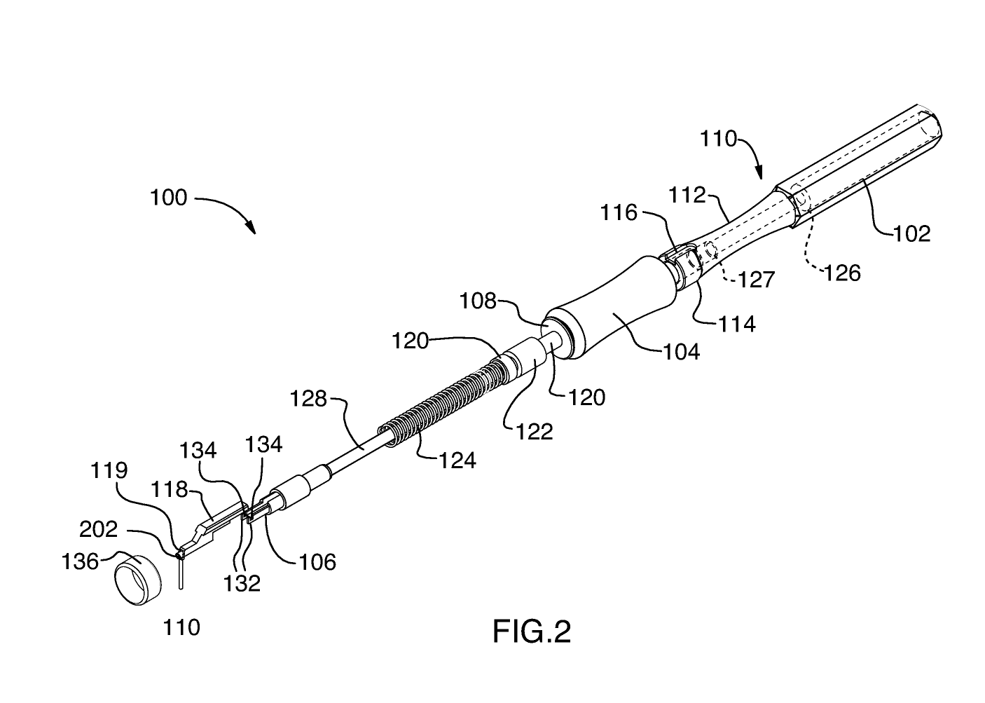

Now referring to FIG. 2, shown is an exploded isometric view of various components of apparatus 100 from FIG. 1, with various inner components shown towards the lower left, grip 104 shown in the middle, and main body 110 shown towards the upper right. For the present purposes of describing a relative position and orientation, the parts of components generally positioned closer towards the upper right part of FIG. 2 will be described as being an “upper portion”, “upper end” or “top end” of the component or apparatus, and the parts of components generally positioned closer toward the lower left part of FIG. 2 will be described as being a “lower portion”, “lower end” or “bottom end” of the component or apparatus. Where appropriate, reference will be made to a “first end” or “second end” of a component, which will be understood as used in context.

Starting from the top right of FIG. 2, the main body 110 of apparatus 100 is a generally elongate tube or housing having an upper portion forming handle 102 and a lower portion adapted to receive a grip 104 thereon. Main body 110 may be formed from a metal or plastic, with suitable dimensions such as length and thickness sufficient to provide structural strength while also having a reasonable weight for comfortable handling and repeated use by an assembly worker.

Still referring to FIG. 2, in this illustrative example, the lower portion of main body 110 includes a neck portion 112 which is narrower than the rest of main body 110. Neck portion 112 may be adapted to receive grip 104 which may be formed from a flexible, stretchable material (such as rubber or foam) so that it can be stretched over a lower end 114 of main body 110 to cover neck portion 112.

In an embodiment, lower end 114 of main body 110 includes a channel or slot 116 suitably sized and adapted to receive a mounting end of an anvil 118, described in more detail below. Slot 116 may be suitably shaped and sized to receive and secure a mounting end of anvil 118 therein. A matching outer sleeve 136 may be used to hold the mounting end of anvil 118 in position within slot 116. While not shown in this illustrative example, sleeve 136 may include, for example, internal threads to match external threads provided on lower end 114 of main body 110. Sleeve 136 may thus be adapted to be screwed onto a threaded portion of lower end 114 of main body 110 to securely hold the mounting end of anvil 118 within slot 116.

Still referring to FIG. 2, shown next to the grip 104 is pad 108 discussed previously with reference to FIG. 1. As noted above, when assembled, resiliently deformable grip 104 covers neck portion 112 of main body 110, and pad 108 is positioned at the upper or second end of main body 110. In normal usage, pad 108 may be depressed during operation of apparatus 100 in order to operate grasping tip 106, as will be described in more detail further below. As shown, pad 108 is connected to a plunger 120 which is slidingly supported by a plunger sleeve 122. Plunger sleeve 122 is normally fixed in position inside and near an upper end of main body 110. The lower end of plunger 120 is shown extending below plunger sleeve 122, and connected to an upper end of an elongate rod 128, such that when plunger 120 is depressed, rod 128 moves together with plunger 120 generally along the center axis of apparatus 100. A lower end of rod 128 is connected to a cable connector grasping tip 130, which has an upper end that is generally thicker than rod 128.

Still referring to FIG. 2, the lower end of plunger 120 engages an upper end of a biasing means 124. The biasing means 124 is contained within a tube formed inside the upper handle 102 portion of the main body 110, and the bottom end of biasing means 124 rests against a first ledge 126, also formed inside the upper handle 102 portion of main body 110. When assembled and in operating position, biasing means 124 is positioned to urge the plunger 120 away from first ledge 126, with the extension of plunger 120 away from first ledge 126 being limited by the upper end of grasping tip 106 engaging a second ledge 127 formed inside the lower neck portion 112 of main body 110.

Still referring to FIG. 2, in this illustrative embodiment, biasing means 124 is a compression spring suitably selected to have sufficient resiliency and fatigue resistance for long-term operation within the apparatus 100. In a preferred embodiment, biasing means 124 is a metal spring selected to have a suitable spring constant k and capable of a force that is sufficient for urging the grasping tip 106 of apparatus 100 to firmly grasp a cable connector (as will be described in more detail below). However, the force necessary to depress pad 108 should not be so high that it is difficult for an assembly worker to repeatedly apply the force with his/her thumb while grasping the body of apparatus 100 with the palm and fingers of the same hand.

While a metal compression spring is shown by way of illustrative example, it will be appreciated that biasing means 124 may be any suitable resiliently compressible part or a plurality of such parts capable of repeatedly providing the required force.

In a preferred embodiment, at a lower end, cable connector grasping tip 106 has two grasping prongs 132 with notches 134 formed along one side of grasping prongs 132. As will be explained in more detail below, notches 134 are suitably shaped, sized and positioned on grasping prongs 132 to receive flanges 204 provided on either side of cable connector 202 (e.g. as previously shown in FIG. 1B). Notches 134 also provide sufficient clearance to allow grasping prongs 132 to be retracted to engage flanges 204, or extended to disengage flanges 204 as described in more detail further below.

Still referring to FIG. 2, as previously described, anvil 118 is received and mounted in slot 116 and thus remains firmly fixed relative to main body 110 at all times. At a lower end, anvil 118 provides a solid anvil face 119 against which a cable connector 202 is buttressed when the flanges 204 of cable connector 202 are received in and engaged by notches 134 of grasping prongs 132. In an embodiment, the anvil face 119 is generally flat and oriented perpendicularly to a center axis running along the length of apparatus 100 and main body 110. Thus, anvil face 119 is adapted to orient and hold the cable connector 202 squarely as an assembly worker attempts to insert cable connector 202 into a receptacle. The operation of apparatus 100 in use will now be described in more detail.

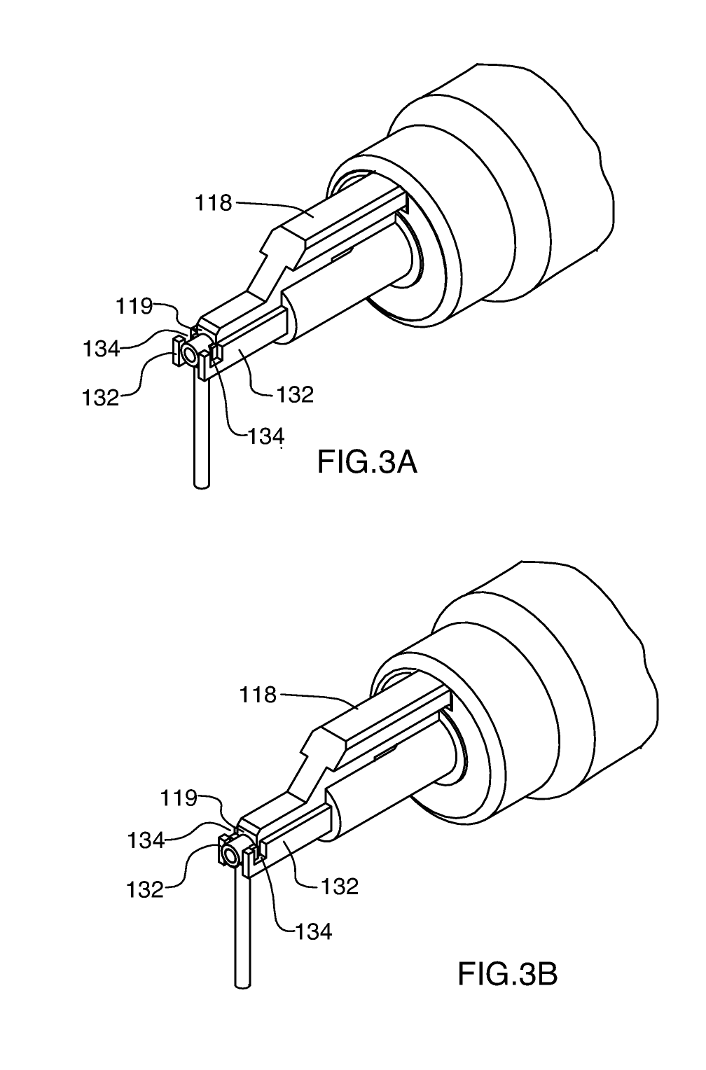

Now referring to FIGS. 3A and 3B, shown in greater detail is the grasping operation of grasping prongs 132 which may be retracted and extended relative to the anvil face 119 of anvil 118 in order to engage and disengage cable connector 202. In FIG. 3A, grasping prongs 132 are shown in an extended position, resulting from pad 108 being depressed by an assembly worker (e.g. using his/her thumb). In this extended position of grasping prongs 132, there is a sufficient clearance between notches 134 and flanges 204 on the cable connector 202 to allow flanges 204 to slide into and be received by notches 134.

Now referring to FIG. 3B, once the cable connector 202 is received in position and pad 108 is partly released, the pair of grasping prongs 132 retract with flanges 204 still received within notches 134. Once the pad 108 is fully released, flanges 204 are engaged within notches 134 and the cable connector 202 is buttressed against anvil face 119.

In use, sufficient force is applied by biasing means 124 such that cable connector 202 is securely held in place even as an assembly worker moves the cable connector 202 and the attached cable 201 around and into a suitable position for insertion into a receptacle provided on a PCB. Advantageously, once cable connector 202 is securely engaged by the cable connector grasping tip 130, and oriented properly against the anvil face 119 as shown in FIG. 3B, an assembly worker may hold the apparatus 100 using only one hand in a position similar to a writing instrument, providing the dexterity necessary for inserting cable connector 202 into a receptacle, even when wearing ESD gloves.

Thus, in an aspect, there is provided an apparatus for grasping a cable connector, comprising: a generally elongate body; an anvil face positioned at a first end of the generally elongate body; a cable connector grasping tip positioned at the first end of the generally elongate body, the cable connector grasping tip adapted to be positionable into an extended position and a retracted position relative to the anvil face; biasing means adapted to urge the cable connector grasping tip into the retracted position; and a pad positioned at a second end of the generally elongate body, the pad adapted to be depressible against the biasing means to urge the cable connector grasping tip into the extended position.

In an embodiment, the anvil face is generally flat and perpendicular to a center axis of the generally elongate body, and the cable connector grasping tip further comprises grasping prongs adapted to be slidably positionable relative to the anvil face.

In another embodiment, the grasping prongs include notches formed into one side of each prong, the notches being adapted to receive therein flanges provided on a cable connector.

In another embodiment, the notches are sized and adapted to provide a clearance to receive flanges provided on a cable connector when the prongs are in the extended position; and to engage the flanges to buttress the cable connector against the anvil face in the retracted position.

In another embodiment, the biasing means is a compression spring selected to have a spring constant providing a force sufficient to maintain a grasp of the cable connector and an attached cable for the purposes of inserting the cable connector into a receptacle.

In another embodiment, in use the generally elongate body of the apparatus is adapted to be gripped in one hand in a first position, and the pad positioned at the second end of the generally elongate body is adapted to be depressible using a thumb of the same one hand.

In another embodiment, the apparatus further comprises a resiliently deformable grip provided on a lower portion of the generally elongate body, the resiliently deformable grip adapted to allow the apparatus to be held in one hand in a second position analogous to holding a writing implement.

In another embodiment, the anvil face is provided on an anvil mounted in a fixed position relative to the generally elongate body.

In another embodiment, a lower end of the generally elongate body includes a mounting slot for receiving a mounting end of the anvil.

In another embodiment, the apparatus further comprises an outer sleeve adapted to be received onto the lower end of the generally elongate body, to keep the anvil fixed in position in the mounting slot.

In another embodiment, the anvil is replaceable, and the mounting slot for receiving a mounting end of the anvil is adapted to receive a mounting end of another anvil having different dimensions adapted to buttress a cable connector of different size.

In another embodiment, the cable connector grasping tip is adapted to be replaceable with another cable connector grasping tip having different dimensions to receive and engage a cable connector of different size.

In another embodiment, the biasing means is replaceable with another biasing means adapted to provide a lesser or greater force sufficient to keep a cable connector engaged within the cable connector grasping tip.

While illustrative embodiments have been described above, it will be appreciated that various changes and modifications may be made. More generally, the scope of the invention is defined by the following claims.

What is claimed is:

1. An apparatus for grasping a cable connector, comprising:
a generally elongate body;
an anvil face positioned at a first end of the generally elongate body;
a cable connector grasping tip positioned at the first end of the generally elongate body, the cable connector grasping tip adapted to be positionable into an extended position and a retracted position relative to the anvil face;
biasing means adapted to urge the cable connector grasping tip into the retracted position; and
a pad positioned at a second end of the generally elongate body, the pad adapted to be depressible against the biasing means to urge the cable connector grasping tip into the extended position.

2. The apparatus of claim 1, wherein the anvil face is generally flat and perpendicular to a center axis of the generally elongate body, and the cable connector grasping tip further comprises grasping prongs adapted to be slidably positionable relative to the anvil face.

3. The apparatus of claim 2, wherein the grasping prongs include notches formed into one side of each prong, the notches being adapted to receive therein flanges provided on a cable connector.

4. The apparatus of claim 2, wherein the notches are sized and adapted to provide a clearance to receive flanges provided on a cable connector when the prongs are in the extended position; and to engage the flanges to buttress the cable connector against the anvil face in the retracted position.

5. The apparatus of claim 1, wherein the biasing means is a compression spring selected to have a spring constant providing a force sufficient to maintain a grasp of the cable connector and an attached cable for the purposes of inserting the cable connector into a receptacle.

6. The apparatus of claim 1, wherein in use the generally elongate body of the apparatus is adapted to be gripped in one hand in a first position, and the pad positioned at the second end of the generally elongate body is adapted to be depressible using a thumb of the same one hand.

7. The apparatus of claim 6, further comprising a resiliently deformable grip provided on a lower portion of the generally elongate body, the resiliently deformable grip adapted to allow the apparatus to be held in one hand in a second position analogous to holding a writing implement.

8. The apparatus of claim 2, wherein the anvil face is provided on an anvil mounted in a fixed position relative to the generally elongate body.

9. The apparatus of claim 8, wherein a lower end of the generally elongate body includes a mounting slot for receiving a mounting end of the anvil.

10. The apparatus of claim 9, further comprising an outer sleeve adapted to be received onto the lower end of the generally elongate body, to keep the anvil fixed in position in the mounting slot.

11. The apparatus of claim 8, wherein the anvil is replaceable, and the mounting slot for receiving a mounting end of the anvil is adapted to receive a mounting end of another anvil having different dimensions adapted to buttress a cable connector of different size.

12. The apparatus of claim 1, wherein the cable connector grasping tip is adapted to be replaceable with another cable connector grasping tip having different dimensions to receive and engage a cable connector of different size.

13. The apparatus of claim 1, wherein the biasing means is replaceable with another biasing means adapted to provide a lesser or greater force sufficient to keep a cable connector engaged within the cable connector grasping tip.
